(19) United States
(12) Patent Application Publication
(10) Pub. No.: US 2023/0267930 A1
(43) Pub. Date: Aug. 24, 2023

(54) DIALOGUE SYSTEM AND DIALOGUE UNIT

(71) Applicant: AISIN CORPORATION, Kariya (JP)

(72) Inventors: Shin OSUGA, Kariya-shi (JP); Godai TANAKA, Kariya-shi (JP); Ayana NABEKURA, Kariya-shi (JP); Ryota NAKANO, Kariya-shi (JP); Ryota WATANABE, Kariya-shi (JP); Tatsuya SATO, Kariya-shi (JP); Norihide KITAOKA, Toyohashi-shi (JP); Ryota NISHIMURA, Tokushima-shi (JP); Sunao HARA, Okayama-shi (JP); Kengo OHTA, Anan-shi (JP)

(73) Assignee: AISIN CORPORATION, Kariya (JP)

(21) Appl. No.: 18/159,406

(22) Filed: Jan. 25, 2023

(30) Foreign Application Priority Data
Feb. 21, 2022 (JP) 2022-024904

(51) Int. Cl. G10L 15/22; G10L 15/26

(52) U.S. Cl. CPC G10L 15/22; G10L 15/26

(57) ABSTRACT

A dialogue system includes a storage device and an execution device. Scenario data stored in the storage device define a response sentence corresponding to a state and a transition condition for transition to a different state. The execution device executes a text data generation process, a determination process, a scenario response process, a chat process, a storage process, and a return process. The text data generation process is a process of converting a voice of a user into text data. The determination process is a process of determining whether the transition condition is satisfied. The scenario response process is a process of operating a speaker so as to make a response when the transition condition is satisfied. The chat process is a process of operating the speaker so as to make a different response when the transition condition is not satisfied.

### CROSS REFERENCE TO RELATED APPLICATIONS

This application is based on and claims priority under 35 U.S.C. § 119 to Japanese Patent Application 2022-024904, filed on Feb. 21, 2022, the entire content of which is incorporated herein by reference.

### TECHNICAL FIELD

This disclosure relates to a dialogue system and a dialogue unit.

### BACKGROUND DISCUSSION

For example, JP 2017-49427A (Reference 1) discloses a dialogue control apparatus for having a dialogue with a user. The dialogue control apparatus estimates emotions of the user to have a dialogue on a topic preferred by the user.

An automaton is well known as a technique for representing a state of a dialogue. Specifically, a scenario of the dialogue is created in advance. The scenario is expanded according to a transition described by the automaton. In this case, the dialogue control apparatus has a dialogue according to the transition described by the automaton.

In the above case, when the user brings up an unexpected topic out of the scenario, the dialogue control apparatus cannot respond. It is difficult to create a scenario in advance based on an assumption of all states so as to avoid such a situation.

### SUMMARY

According to an aspect of this disclosure, a dialogue system includes: a storage device; and an execution device, in which scenario data is stored in the storage device, and the scenario data is data defining a response sentence corresponding to a state and a transition condition for transition to a different state. The execution device executes a text data generation process, a determination process, a scenario response process, a chat process, a storage process, and a return process, the text data generation process is a process of converting a voice of a user into text data using an output signal of a microphone as input, the determination process is a process of determining whether the transition condition is satisfied based on the text data and the scenario data, the scenario response process is a process of operating a speaker so as to make a response based on a response sentence defined in a state of a transition destination according to the transition condition based on the scenario data when it is determined that the transition condition is satisfied, the chat process is a process of operating the speaker so as to make a response different from the response based on the response sentence defined in the scenario data when it is determined that the transition condition is not satisfied, the storage process is a process of storing and maintaining a state before execution of the chat process in the storage device when the chat process is to be executed, and the return process is a process of returning to the stored and maintained state when the chat process ends.

According to another aspect of this disclosure, a dialogue unit is a dialogue unit included in the above dialogue system.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram illustrating a configuration of a dialogue system according to an embodiment;

FIG. 2 is a diagram illustrating an example of scenario data according to the embodiment;

FIG. 3 is a diagram illustrating an example of a transition of states of an automaton according to the embodiment;

(a) and (b) of FIG. 4 are flowcharts illustrating procedures of processes executed by the dialogue system according to the embodiment; and

FIG. 5 is a diagram illustrating an example of a dialogue according to the embodiment.

### DETAILED DESCRIPTION

Hereinafter, an embodiment will be described with reference to the drawings.

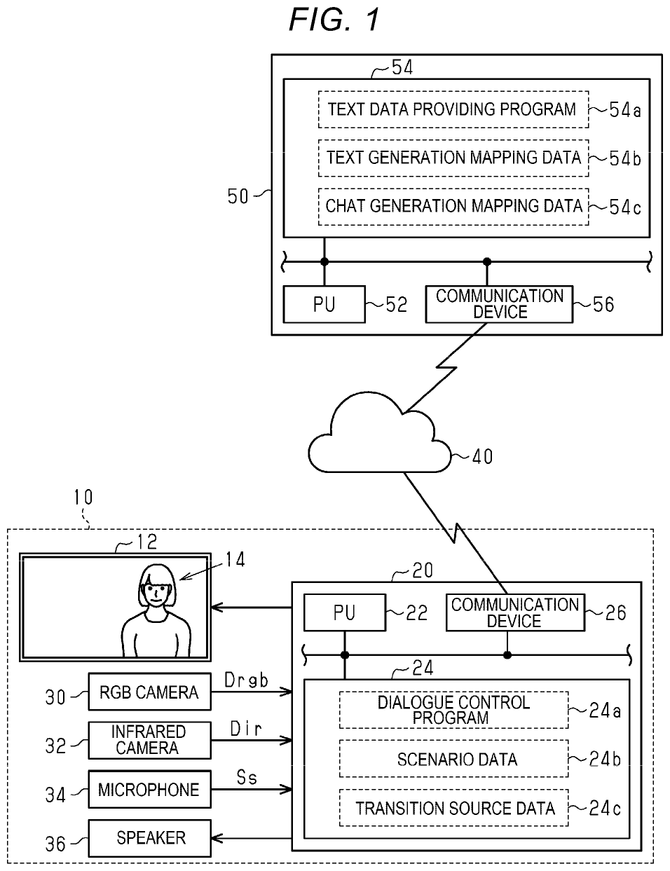

FIG. 1 illustrates a configuration of a dialogue system. A dialogue unit 10 illustrated in FIG. 1 includes a display unit 12. The display unit 12 is, for example, a display panel including an LCD, an LED, and the like. An agent image 14, which is an image of a virtual person having a dialogue with a user, is displayed on the display unit 12.

The control device 20 operates the display unit 12 to control an image displayed on the display unit 12. At this time, the control device 20 refers to RGB image data Drgb output by an RGB camera 30 in order to control the image. The RGB camera 30 is disposed toward a direction in which the user is assumed to be located. The RGB image data Drgb includes luminance data of three primary colors including red, green, and blue. Further, the control device 20 refers to infrared image data Dir output by an infrared camera 32 in order to control the image. The infrared camera 32 is also disposed toward the direction in which the user is assumed to be located. In addition, the control device 20 refers to a sound signal Ss output by a microphone 34 in order to control the image. The microphone 34 is provided to sense a sound signal generated by the user.

The control device 20 operates a speaker 36 to output a sound signal in accordance with an action in the agent image 14.

The control device 20 includes a PU 22, a storage device 24, and a communication device 26. The PU 22 is a software processing device including at least one of a CPU, a GPU, a TPU, and the like. The storage device 24 stores scenario data 24b. The scenario data 24b includes a finite automaton.

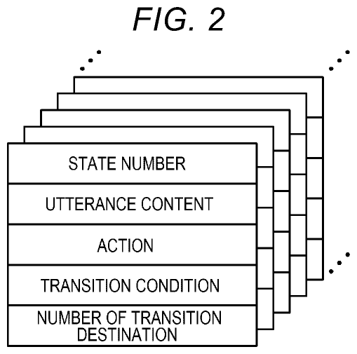

FIG. 2 illustrates an example of the scenario data 24b.

As illustrated in FIG. 2, the scenario data 24b includes data corresponding to a plurality of states, each of which is defined by a state number of an automaton. The scenario data 24b includes data defining, for each of the plurality of states, a state number of the automaton, an utterance content of an agent, an action of the agent, a transition condition of the state, and a state number of a transition destination for each transition condition. Here, the data defining the utterance content of the agent is text data. In particular, the utterance content of the agent in a state of responding to an utterance content of the user is a response sentence for the utterance content of the user. In this case, the data defining the utterance content of the agent is text data representing the response sentence. The data defining the action of the agent is data defining a posture and an action of the agent indicated by the agent image 14. Specifically, the data may be, for example, data designating one of agent images 14 with a plurality of predetermined postures. The data defining the transition condition of the state is data defining a condition of a word included in an expression uttered by the user.

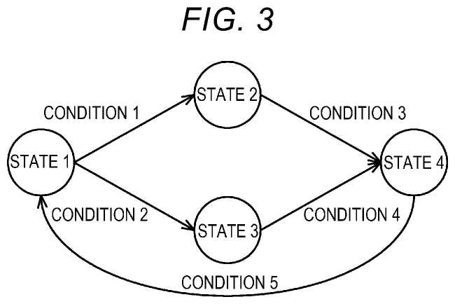

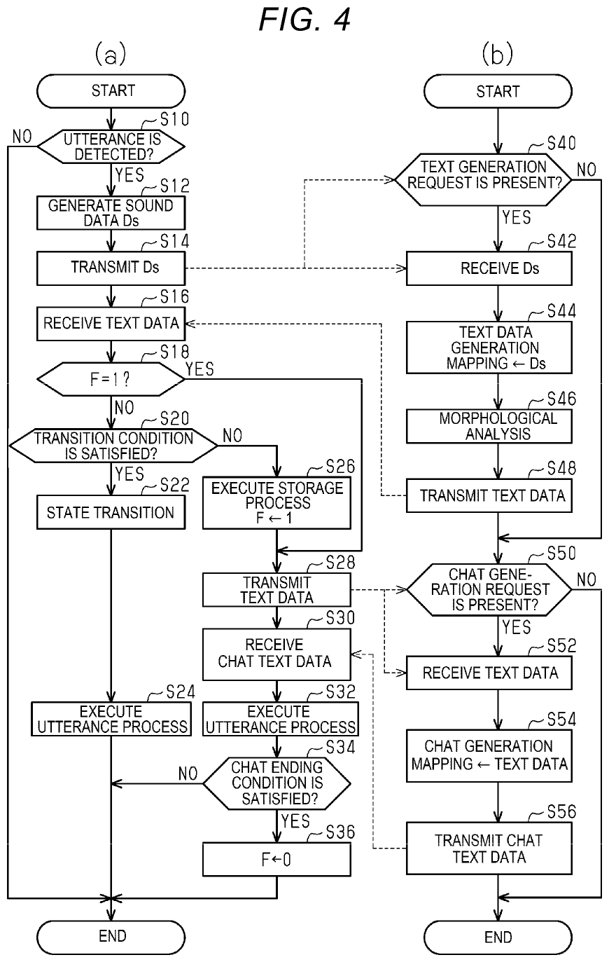

FIG. 3 illustrates an example of a transition of states of the automaton. FIG. 3 illustrates an example in which, in a state denoted by a state number 1, when a condition 1 is satisfied, the automaton transitions to a state denoted by a state number 2, and when a condition 2 is satisfied, the automaton transitions to a state denoted by a state number 3. Therefore, the conditions 1 and 2 are described as transition conditions in the scenario data 24b defining the state denoted by the state number 1. Further, the conditions 1 and 2 are associated with the states denoted by the state numbers 2 and 3, respectively, as transition destinations.

Referring back to FIG. 1, the communication device 26 can communicate with a back-end unit 50 via a network 40. The network 40 is preferably, for example, a global network such as the Internet.

The back-end unit 50 executes a process of processing data transmitted from the dialogue unit 10, and the like. The back-end unit 50 includes a PU 52, a storage device 54, and a communication device 56. The PU 52 is a software processing device including at least one of a CPU, a GPU, a TPU, and the like.

(a) and (b) of FIG. 4 illustrate procedures of processes executed by the dialogue system. Specifically, (a) of FIG. 4 illustrates a procedure of a process executed by the dialogue unit 10. The process illustrated in (a) of FIG. 4 is implemented by the PU 22 repeatedly executing a dialogue control program 24a stored in the storage device 24 illustrated in FIG. 1, for example, at a predetermined cycle. On the other hand, (b) of FIG. 4 illustrates a procedure of a process executed by the back-end unit 50. The process illustrated in (b) of FIG. 4 is implemented by the PU 52 repeatedly executing a text data providing program 54a stored in the storage device 54 illustrated in FIG. 1, for example, at a predetermined cycle. In (a) and (b) of FIG. 4, step numbers in each process are represented by numbers with “S” added to the front thereof. Hereinafter, the processes illustrated in (a) and (b) of FIG. 4 will be described in time series of processes executed by the dialogue system.

In a series of processes illustrated in (a) of FIG. 4, the PU 22 determines whether an utterance is detected (S10). This process may be, for example, a process of determining whether a sound pressure level of a predetermined frequency component of the sound signal Ss is equal to or greater than a predetermined value. In this case, when it is determined that the sound pressure level is equal to or greater than the predetermined value, it may be determined that the utterance is detected. Further, for example, it may be a process in which it is determined whether a logical product of a fact that the sound pressure level of the predetermined frequency component of the sound signal Ss is equal to or greater than the predetermined value and a fact that a face orientation of the user based on the infrared image data Dir is a predetermined direction is true. In this case, when the logical product is true, it may be determined that the utterance is detected.

When it is determined that the utterance is detected (S10: YES), the PU 22 converts the sound signal Ss as an analog signal into digital sound data Ds (S12). Then, the PU 22 operates the communication device 26 to transmit the sound data Ds to the back-end unit 50 (S14). Specifically, at this time, the PU 22 also transmits, in addition to the sound data Ds, a request for converting the sound data Ds into text data to the back-end unit 50.

When the process of S14 is executed, the PU 52 of the back-end unit 50 determines that a text generation request is present as illustrated in (b) of FIG. 4 (S40: YES). Then, the PU 52 receives the sound data Ds (S42). Then, the PU 52 converts the sound data Ds into text data by inputting the sound data Ds to a text data generation mapping (S44). The text data generation mapping is a mapping defined by text generation mapping data 54b stored in the storage device 54 illustrated in FIG. 1. A text generation mapping is a trained model based on machine learning. The text generation mapping may use, for example, a neural network such as an encoder and decoder model. In addition, for example, a hidden Markov model (hereinafter, referred to as HMM) may be used. Further, for example, both the HMM and the neural network may be used.

Next, the PU 52 decomposes the text data into words by morphological analysis (S46). Then, the PU 52 operates the communication device 56 to transmit the text data decomposed into words to the dialogue unit 10 (S48).

On the other hand, as illustrated in (a) of FIG. 4, the PU 22 of the dialogue unit 10 receives the text data (S16). Then, the PU 22 determines whether a flag F is “1” (S18). The flag F is set to “0” when a dialogue is in progress according to a scenario defined in the scenario data 24b, and is set to “1” when the dialogue deviates from the scenario. When it is determined that the flag F is “0” (S18: NO), the PU 22 determines whether a transition condition is satisfied (S20). This is a process of determining whether a transition condition defined by data indicating a current state number in the scenario data 24b is satisfied. Here, the PU 22 determines whether the transition condition is satisfied according to a match or a mismatch between a word included in the text data received in the process of S16 and a word included in the transition condition.

When it is determined that the transition condition is satisfied (S20: YES), the PU 22 causes a transition of the state to a transition destination associated with the transition condition (S22). Then, the PU 22 operates the speaker 36 to execute an utterance process according to the utterance content defined by the state number of the transition destination based on the scenario data 24b (S24). That is, the PU 22 causes the speaker 36 to output a sound signal corresponding to the utterance content.

On the other hand, when it is determined that the transition condition is not satisfied (S20: NO), the PU 22 stores the data indicating the current state number in the storage device 24 as transition source data 24c (S26). In addition, the PU 22 substitutes “1” into the flag F. Then, the PU 22 operates the communication device 26 to transmit the text data indicating the utterance content of the user received in the process of S16 to the back-end unit 50 (S28). Specifically, at this time, the PU 22 transmits, in addition to the text data, a request for generating a chat corresponding to the text data to the back-end unit 50.

When the process of S28 is executed, the PU 52 of the back-end unit 50 determines that a chat generation request is present as illustrated in (b) of FIG. 4 (S50: YES). Then, the PU 52 receives the text data transmitted in the process of S28 (S52). Then, the PU 52 generates chat text data by inputting the received text data to a chat generation mapping (S54). The chat generation mapping is data defined by chat generation mapping data 54c stored in the storage device 54 illustrated in FIG. 1. The chat generation mapping is a trained model formed by learning based on machine learning. The chat generation mapping may be a mapping for retrieving, from a knowledge database, text data related to the received text data and outputting the text data. In this case, it is assumed that the chat generation mapping data 54c includes the knowledge database. The chat generation mapping may be implemented using, for example, an encoder and decoder model. In addition, the chat generation mapping may be implemented by, for example, a neural network including an attention mechanism.

The PU 52 operates the communication device 56 to transmit the chat text data to the dialogue unit 10 (S56). The PU 52 temporarily ends a series of processes illustrated in (b) of FIG. 4 when the process of S56 is completed and when it is determined to be NO in the process of S50.

On the other hand, as illustrated in (a) of FIG. 4, the PU 22 of the dialogue unit 10 receives the chat text data (S30). Then, the PU 22 converts the chat text data into sound data, and then operates the speaker 36 to execute the utterance process (S32). That is, the PU 22 causes the speaker 36 to output a sound signal corresponding to the chat text data. Next, the PU 22 determines whether a chat ending condition is satisfied (S34). The chat ending condition may be, for example, a condition for completing the process of S32. In addition, for example, the chat ending condition may be a condition that a predetermined word such as “that's it” is included in an expression uttered by the user.

When the PU 22 determines that the chat ending condition is satisfied (S34: YES), the PU 22 substitutes “0” into the flag F (S36). The PU 22 temporarily ends the series of processes illustrated in (a) of FIG. 4 when the processes of S24 and S36 are completed and when it is determined to be NO in the processes of S10 and S34.

Here, functions and effects according to the present embodiment will be described.

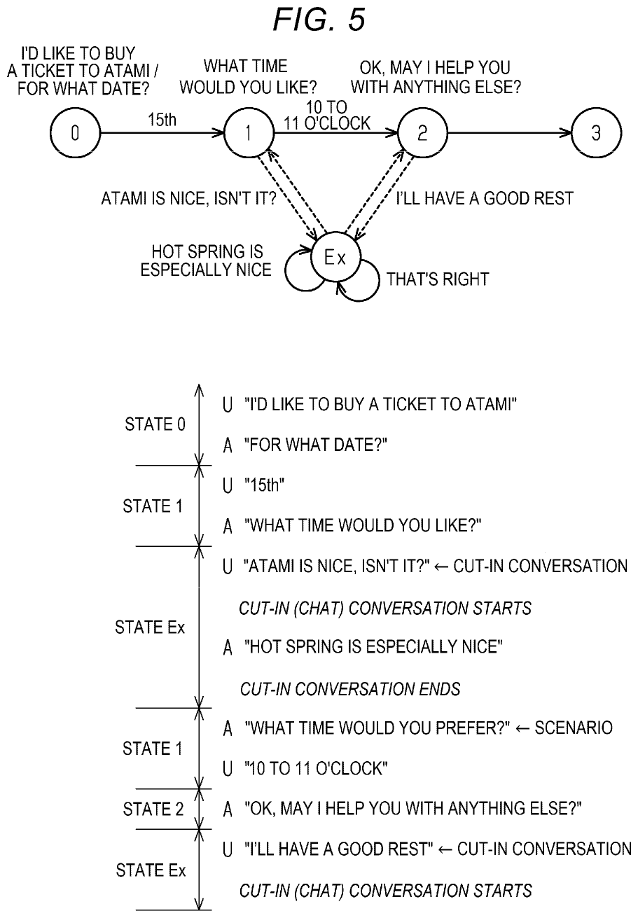

FIG. 5 illustrates an example of a dialogue between the dialogue system and the user. Here, a dialogue at a ticket office is exemplified. It is assumed that transition conditions for a transition in an order of a state number 0, a state number 1, a state number 2, and a state number 3 are set in the scenario data 24b. In the drawing, “U” is referred to as utterances of a user, and “A” is referred to as utterances of an agent.

In FIG. 5, in response to an utterance of the user that “I'd like to buy a ticket to Atami”, the dialogue system utters “For what date?” The user answers “15th” as a response. As a response to “For what date?”, “15th” is a content according to a scenario, and thus the automaton transitions to a state denoted by the state number 1. This can be implemented by including, in the transition condition of the state number 0 defined by the scenario data 24b, a condition that any one of “1st, 2nd, 3rd, . . . , and 31st” is included.

Then, according to an utterance content defined by the state number 1 in the scenario data 24b, the dialogue system utters “What time would you like?” In the example illustrated in FIG. 5, the user utters “Atami is nice, isn't it?” The transition condition defined by the state number 1 includes a condition that a word indicating time is included in the expression of the user. Thus, when the user utters “Atami is nice, isn't it?”, the transition condition is not satisfied. Therefore, the dialog system stores the state number 1 in the storage device 24 as the transition source data 24c. Then, the dialogue system uses the chat generation mapping to generate the chat text data, converts the chat text data into a sound signal, and utters the sound signal. In FIG. 5, this is referred to as a state Ex.

In the example illustrated in FIG. 5, the chat ending condition is set as completion of the process of S32. Therefore, when the dialogue system ends with an utterance of “hot spring is especially nice” according to the chat text data, the dialogue system repeats the utterance content defined by the state number 1 in the scenario data 24b. FIG. 5 illustrates an example in which, in this case, the dialogue system makes an utterance according to the text data having the same contents and different expressions as those of a previous time, which is “What time would you prefer”. This means that the response can be implemented by including two response sentences, “What time would you like?” and “What time would you prefer”, in the utterance content defined by the state number 1.

In this manner, when the transition condition in the scenario data 24b is not satisfied, the PU 22 stores the current state number in the storage device 24 as the transition source data 24c. Then, the PU 22 uses the chat generation mapping to continue a conversation with the user. Therefore, even when a conversation content of the user deviates from the scenario defined by the scenario data 24b, the dialogue system can cope with this situation.

According to the present embodiment described above, functions and effects are further obtained as follows.

(1) The chat generation mapping is used as the trained model. Accordingly, it is possible to form a chat process without relying on a scenario-type dialogue process.

(2) The chat text data is generated by the back-end unit 50. Accordingly, a calculation load of the dialogue unit 10 can be reduced as compared with a case in which the dialogue unit 10 generates the chat text data.

(3) The sound data Ds obtained by converting a voice of the user into digital data is converted into text data in the back-end unit 50. Accordingly, the calculation load of the dialogue unit 10 can be reduced as compared with a case in which the dialogue unit 10 executes the process of converting into the text data. In addition, as compared to the case in which the dialogue unit 10 executes the process of converting into the text data, a highly accurate external service of converting the sound data Ds into text data can be used.

### <Correspondence Relationship>

Correspondence between matters in the above embodiment and matters described in a section of “Solution to Problem” is as follows. Hereinafter, a correspondence relationship is shown for each number in the solution described in the section of “Solution to Problem”. [1] A storage device corresponds to the storage devices 24 and 54. An execution device corresponds to the PUs 22 and 52. A text data generation process corresponds to the process of S44. A determination process corresponds to the process of S20. A scenario response process corresponds to the process of S24. A chat process corresponds to processes of S28 to S32 and processes of S50 to S56. A storage process corresponds to the process of S26. A return process corresponds to the process of S36 when it is determined to be YES in the process of S34. [2] Chat generation mapping data corresponds to the chat generation mapping data 54c. [3, 5] A first storage device corresponds to the storage device 24. A second storage device corresponds to the storage device 54. A first execution device corresponds to the PU 22. A second execution device corresponds to the PU 54. A first communication device corresponds to the communication device 26. A second communication device corresponds to the communication device 56. A chat text data calculation process corresponds to the process of S54. A response sentence transmission process corresponds to the process of S56. A response sentence reception process corresponds to the process of S30. [4] A text data transmission process corresponds to the process of S48. A text data reception process corresponds to the process of S16.

### Other Embodiments

The present embodiment may be modified and implemented as follows. The present embodiment and the following modifications can be implemented in combination with each other within a range that the embodiment and the modifications do not technically contradict each other.

### “Regarding Chat Generation Mapping”

In the above embodiment, an example is described in which the chat generation mapping data 54c defining the chat generation mapping is trained data based on machine learning, but this disclosure is not limited thereto. For example, the chat generation mapping data 54c may be a scenario-type chatbot or the like. Even in this case, when the chatbot or the like is an external service provided via the network 40, it is possible to prevent the scenario data 24b in the dialogue unit 10 from becoming complicated.

### “Regarding Chat Process”

In (a) and (b) of FIG. 4, for convenience of description, an example is described in which the processes of S26 to S36 are defined by the dialogue control program 24a, but this disclosure is not limited thereto. For example, by storing data defining an automaton for a chat in the storage device 24, a process using the same data may be executed. That is, in this case, the data defining a chat automaton includes data defining that the processes of S26 to S32 are to be executed and data defining a state defined by the transition source data 24c as a transition destination when a predetermined ending condition is satisfied.

The chat process is not limited to the process executed by the back-end unit 50. For example, the chat process may be implemented by the PU 22 alone by storing the chat generation mapping data 54c in the storage device 24.

### “Regarding Text Data Generation Process”

In the processes illustrated in (a) and (b) of FIG. 4, the morphological analysis of the text data is performed in the back-end unit 50, but this disclosure is not limited thereto. For example, the back-end unit 50 may transmit the generated text data to the dialogue unit 10 after executing the process of S44. In this case, the morphological analysis may be performed in the dialogue unit 10.

The text data generation process is not limited to the process executed by the back-end unit 50. For example, the text data generation process may be implemented by the PU 22 alone by storing the text generation mapping data 54b in the storage device 24.

### “Regarding Scenario Data”

The scenario data is not limited to data including an action of the agent. For example, the scenario data may be data including utterance contents such as a response sentence while not including the action of the agent.

### “Regarding Display Device”

A display device is not limited to a device including the display unit 12. For example, holography may be used. In addition, for example, a head-up display or the like may be used.

### “Regarding Dialogue Unit”

It is not essential that the dialogue unit includes the display device.

### “Regarding Dialogue System”

It is not essential that the dialogue system includes the back-end unit 50.

### “Regarding Execution Device”

The execution device is not limited to a device that executes a software process such as a CPU, a GPU, and a TPU. For example, the execution device may include a dedicated hardware circuit such as an ASIC that executes a hardware process on at least a part of data which is subjected to the software process in the above embodiment. That is, the execution device may have any one of the following configurations (a) to (c). (a) A processing device that executes all of the above processes according to a program, and a program storage device that stores the program are provided. (b) A processing device that executes a part of the above processes according to a program, a program storage device, and a dedicated hardware circuit that executes the remaining processes are provided. (c) A dedicated hardware circuit that executes all of the above processes is provided. Here, a plurality of software execution devices including the processing device and the program storage device and a plurality of dedicated hardware circuits may be provided.

Hereinafter, a method for solving the problems of the related art and functions and effects thereof will be described.

1. A dialogue system includes: a storage device; and an execution device, in which scenario data is stored in the storage device, and the scenario data is data defining a response sentence corresponding to a state and a transition condition for transition to a different state. The execution device executes a text data generation process, a determination process, a scenario response process, a chat process, a storage process, and a return process, the text data generation process is a process of converting a voice of a user into text data using an output signal of a microphone as input, the determination process is a process of determining whether the transition condition is satisfied based on the text data and the scenario data, the scenario response process is a process of operating a speaker so as to make a response based on a response sentence defined in a state of a transition destination according to the transition condition based on the scenario data when it is determined that the transition condition is satisfied, the chat process is a process of operating the speaker so as to make a response different from the response based on the response sentence defined in the scenario data when it is determined that the transition condition is not satisfied, the storage process is a process of storing and maintaining a state before execution of the chat process in the storage device when the chat process is to be executed, and the return process is a process of returning to the stored and maintained state when the chat process ends.

In the above configuration, when the text data based on the voice of the user satisfies the transition condition, a response at a state after transition according to the transition condition is made. In contrast, when the transition condition is not satisfied, the process proceeds to the chat process. The chat process is a process of making a response different from the response based on the response sentence defined in the above scenario data. Therefore, it is possible to respond to a topic of the user while preventing the above scenario data from becoming complicated.

2. In the dialogue system according to 1, the return process is executed when the response of the chat process ends or when the user utters a predetermined word related to an end of a chat.

In the above configuration, when an utterance process is executed, it is possible to determine whether a chat ending condition is satisfied.

3. In the dialogue system according to 1, chat generation mapping data is stored in the storage device, the chat generation mapping data is trained data defining chat generation mapping that outputs a response sentence with respect to input, and the chat process includes a process of inputting, to the chat generation mapping, data corresponding to the text data when it is determined that the transition condition is not satisfied, so as to obtain output of the chat generation mapping.

In the above configuration, chat generation mapping defined by trained data is used. Accordingly, it is possible to form a chat process without relying on a scenario-type dialogue process.

4. The dialogue system according to 3 further includes: a dialogue unit; and a back-end unit, in which the storage device includes a first storage device and a second storage device, the execution device includes a first execution device and a second execution device, the dialogue unit includes the first storage device, the first execution device, and a first communication device, the back-end unit includes the second storage device, the second execution device, and a second communication device, the scenario data is stored in the first storage device, the chat generation mapping data is stored in the second storage device, the chat process includes a chat text data calculation process, a response sentence transmission process, and a response sentence reception process, the chat text data calculation process is executed by the second execution device and is a process of calculating output of the chat generation mapping corresponding to the text data when it is determined that the transition condition is not satisfied, the response sentence transmission process is a process of transmitting a response sentence corresponding to the output of the chat generation mapping by the second execution device operating the second communication device, and the response sentence reception process is a process of receiving the response sentence corresponding to the output by the first execution device operating the first communication device.

In the above configuration, the chat text data calculation process is executed outside the dialogue unit, so that a calculation load of the first execution device can be reduced as compared with a case in which the first execution device executes the chat text data calculation process.

5. In the dialogue system according to 4, the first execution device executes a text data reception process, the second execution device executes a text data transmission process, the text data generation process is executed by the second execution device, the text data transmission process is a process of transmitting the text data generated by the text data generation process to the dialogue unit by the second execution device operating the second communication device, and the text data reception process includes a process of receiving the text data by the first execution device operating the first communication device.

In the above configuration, the text data generation process is executed outside the dialogue unit, so that the calculation load of the first execution device can be reduced as compared with a case in which the first execution device executes the text data generation process.

6. A dialogue unit, which is the dialogue unit included in the dialogue system according to 4 or 5.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A dialogue system comprising:
a storage device; and
an execution device, wherein
scenario data is stored in the storage device,
the scenario data is data defining a response sentence corresponding to a state and a transition condition for transition to a different state,
the execution device executes a text data generation process, a determination process, a scenario response process, a chat process, a storage process, and a return process,
the text data generation process is a process of converting a voice of a user into text data using an output signal of a microphone as input,
the determination process is a process of determining whether the transition condition is satisfied based on the text data and the scenario data,
the scenario response process is a process of operating a speaker so as to make a response based on a response sentence defined in a state of a transition destination according to the transition condition based on the scenario data when it is determined that the transition condition is satisfied,
the chat process is a process of operating the speaker so as to make a response different from the response based on the response sentence defined in the scenario data when it is determined that the transition condition is not satisfied,
the storage process is a process of storing and maintaining a state before execution of the chat process in the storage device when the chat process is to be executed, and
the return process is a process of returning to the stored and maintained state when the chat process ends.

2. The dialogue system according to claim 1, wherein
the return process is executed when the response of the chat process ends or when the user utters a predetermined word related to an end of a chat.

3. The dialogue system according to claim 1, wherein
chat generation mapping data is stored in the storage device,
the chat generation mapping data is trained data defining chat generation mapping that outputs a response sentence with respect to input, and
the chat process includes a process of inputting, to the chat generation mapping, data corresponding to the text data when it is determined that the transition condition is not satisfied, so as to obtain output of the chat generation mapping.

4. The dialogue system according to claim 3, further comprising:
a dialogue unit; and
a back-end unit, wherein
the storage device includes a first storage device and a second storage device,
the execution device includes a first execution device and a second execution device,
the dialogue unit includes the first storage device, the first execution device, and a first communication device,
the back-end unit includes the second storage device, the second execution device, and a second communication device,
the scenario data is stored in the first storage device,
the chat generation mapping data is stored in the second storage device,
the chat process includes a chat text data calculation process, a response sentence transmission process, and a response sentence reception process,
the chat text data calculation process is executed by the second execution device and is a process of calculating output of the chat generation mapping corresponding to the text data when it is determined that the transition condition is not satisfied,
the response sentence transmission process is a process of transmitting a response sentence corresponding to the output of the chat generation mapping by the second execution device operating the second communication device, and
the response sentence reception process is a process of receiving the response sentence corresponding to the output by the first execution device operating the first communication device.

5. The dialogue system according to claim 4, wherein
the first execution device executes a text data reception process,
the second execution device executes a text data transmission process,
the text data generation process is executed by the second execution device,
the text data transmission process is a process of transmitting the text data generated by the text data generation process to the dialogue unit by the second execution device operating the second communication device, and
the text data reception process includes a process of receiving the text data by the first execution device operating the first communication device.

6. A dialogue unit, which is the dialogue unit included in the dialogue system according to claim 4.

7. A dialogue unit, which is the dialogue unit included in the dialogue system according to claim 5.
